(19) United States
(12) Patent Application Publication
(10) Pub. No.: US 2018/0241234 A1
(43) Pub. Date: Aug. 23, 2018

(54) Methods And Charge Controllers For Charging Of Battery In Electric Vehicle

(71) Applicant: Telefonaktiebolaget LM Ericsson (publ), Stockholm (SE)

(72) Inventors: Hongxin Liang, Upplands Väsby (SE); Azadeh Bararsani, Solna (SE); Elena Fersman, Stockholm (SE); Leonid Mokrushin, Uppsala (SE)

(21) Appl. No.: 15/753,566

(22) PCT Filed: Sep. 10, 2015
(86) PCT No.: PCT/SE2015/050952

§ 371 Date: Feb. 20, 2018

(51) Int. Cl. H02J 7/00; B60L 11/18

(52) U.S. Cl. CPC H02J 7/0054; B60L 11/1862; H02J 7/0047; B60L 11/1846; H02J 2007/005; B60L 2250/16; B60L 2260/52; B60L 2260/54; B60L 2230/40

(57) ABSTRACT

An on-board charge controller (100) of an electric vehicle, a central charge controller (104), and methods therein, for handling battery charge. The central charge controller (104) receives reports from two electric vehicles (100, 102) comprising intended routes to destinations to be travelled by the electric vehicles and an indication of their current battery charge level (100C, 102C). The central charge controller (104) further determines a proposed location where the first and second electric vehicles (100, 102) can exchange battery power, based on the received reports, and sends the proposed location to the first and second electric vehicles (100, 102). The first and second electric vehicles (100, 102) then transfer battery power between the batteries (100B, 102B) of the electric vehicles (100, 102) at the proposed location.

### TECHNICAL FIELD

The present disclosure relates generally to an on-board charge controller of an electric vehicle, a central charge controller, and methods therein, for handling battery charge.

### BACKGROUND

In recent years, vehicles which are powered and propelled by power of a battery have been developed as an environment-friendly alternative to conventional vehicles powered by combustion of petrol or gasoline. Such vehicles powered by a battery are commonly referred to as electric vehicles. Vehicles powered by a combination of petrol combustion and battery, commonly referred to as hybrid electric vehicles, have also been available for some years. The need and desire to reduce air pollution in different areas as well as globally, by using battery powered vehicles instead of by combustion powered vehicles, has been driving this evolution to a great extent. In this disclosure, the term “electric vehicle” is used to denote any vehicle that is powered and propelled by a rechargeable battery that needs to be recharged when drained in order to continue propelling the vehicle.

However, a major drawback so far with such electric vehicles is that the battery becomes quickly drained after driving a rather limited stretch and it must be re-charged frequently, perhaps more than once when travelling to a certain destination before that destination is reached. This must be done at specialized stations that provide charging services, referred to as charging stations being equivalent to petrol stations. Even though the number of such charging stations along several major roads is steadily increasing, it can be assumed that they will remain scarce for some time and there is thus a considerable risk that no charging station is available for travelling electrical vehicles when needed, particularly in rural and desolate areas. Some vast areas may lack charging stations altogether. Another drawback is that the charging process takes considerable time, typically much longer than filling a conventional fuel tank with petrol.

### SUMMARY

It is an object of embodiments described herein to address at least some of the problems and issues outlined above. It is possible to achieve this object and others by using an on-board charge controller, a central charge controller, and methods therein, as defined in the attached independent claims.

According to one aspect, a method is performed by an on-board charge controller of a first electric vehicle powered by a rechargeable battery, for handling battery charge. In this method the on-board charge controller sends, to a central charge controller, a report comprising an intended route to a destination to be travelled by the first electric vehicle and an indication of a current battery charge level. The on-board charge controller then receives, from the central charge controller, a proposed location where a second electric vehicle can exchange battery power with the first electric vehicle.

The on-board charge controller further transfers battery power between a rechargeable battery of the second electric vehicle and the battery of the first electric vehicle at the proposed location. Thereby, it is possible to avoid the above-mentioned problem of running out of battery charge when no charging station is available.

According to another aspect, an on-board charge controller is adapted to operate in a first electric vehicle powered by a rechargeable battery. The on-board charge controller is arranged to handle battery charge and comprises a processor and a memory. The memory comprises instructions executable by said processor whereby the on-board charge controller is operative to:
send, to a central charge controller, a report comprising an intended route to a destination to be travelled by the first electric vehicle and an indication of a current battery charge level,
receive, from the central charge controller, a proposed location where a second electric vehicle can exchange battery power with the first electric vehicle, and
transfer battery power between a rechargeable battery of the second electric vehicle and the battery of the first electric vehicle at the proposed location.

According to another aspect, a method is performed by a central charge controller for handling battery charge in a rechargeable battery of a first electric vehicle and in a rechargeable battery of a second electric vehicle. In this method, the central charge controller receives a first report from the first electric vehicle, the first report comprising an intended route to a first destination to be travelled by the first electric vehicle and an indication of a current battery charge level in the first electric vehicle. The central charge controller also receives a second report from the second electric vehicle, the second report comprising an intended route to a second destination to be travelled by the second electric vehicle and an indication of a current battery charge level in the second electric vehicle.

The central charge controller then determines a proposed location where the first and second electric vehicles can exchange battery power, based on the received first and second reports. The central charge controller further sends the proposed location to the first and second electric vehicles, thereby enabling the first and second electric vehicles to exchange battery power at the proposed location.

According to another aspect, a central charge controller is arranged to handle battery charge in a rechargeable battery of a first electric vehicle and in a rechargeable battery of a second electric vehicle. The central charge controller comprises a processor and a memory, said memory comprising instructions executable by said processor whereby the central charge controller is operative to:
receive a first report from the first electric vehicle, the first report comprising an intended route to a first destination to be travelled by the first electric vehicle and an indication of a current battery charge level in the first electric vehicle,
receive a second report from the second electric vehicle, the second report comprising an intended route to a second destination to be travelled by the second electric vehicle and an indication of a current battery charge level in the second electric vehicle,
determine a proposed location where the first and second electric vehicles can exchange battery power, based on the received first and second reports, and
send the proposed location to the first and second electric vehicles, thereby enabling the first and second electric vehicles to exchange battery power at the proposed location.

The above methods and charge controllers may be configured and implemented according to different optional embodiments to accomplish further features and benefits, to be described below.

A computer program storage product is also provided comprising instructions which, when executed on at least one processor in either of the on-board charge controller and the central charge controller, cause the at least one processor to carry out the respective methods described above for the on-board charge controller and the central charge controller.

### BRIEF DESCRIPTION OF DRAWINGS

The solution will now be described in more detail by means of exemplary embodiments and with reference to the accompanying drawings, in which:

FIG. 1 is a communication scenario illustrating how battery power can be transferred from one electric vehicle to another at a meeting location, according to some possible embodiments.

FIG. 2 is a block diagram illustrating in more detail that battery power is transferred between the electric vehicles of FIG. 1 at the meeting location.

FIG. 3 illustrates another example of a meeting location where battery power may be transferred between two electric vehicles, according to further possible embodiments.

FIG. 4 is a flow chart illustrating a procedure in an on-board charge controller of an electric vehicle, according to further possible embodiments.

FIG. 5 is a flow chart illustrating a procedure in a central charge controller, according to further possible embodiments.

FIG. 6 is a flow chart illustrating a more detailed example of how the procedure of FIG. 5 may be realized in a central charge controller, according to further possible embodiments.

FIG. 7 is a block diagram illustrating an on-board charge controller of an electric vehicle and a central charge controller, according to further possible embodiments.

FIG. 8 is a block diagram illustrating an example of how on-board charge controllers in two electric vehicles may be configured in more detail to enable transfer of battery power, according to further possible embodiments.

FIG. 9 is a signaling diagram illustrating an example of a procedure involving an electric vehicle and a central charge controller when the solution is used, according to further possible embodiments.

### DETAILED DESCRIPTION

Briefly described, a solution is provided to enable a battery in an electric vehicle with insufficient battery power to be recharged, without being dependent on reaching a charging station or the like. This is accomplished by utilizing surplus battery power in another electric vehicle and by arranging for both vehicles to meet at a suitable location where battery power is transferred from one vehicle to the other vehicle. In this solution, such exchange of battery power between vehicles is made possible by having electric vehicles sending reports of their battery status to a central charge controller which in turn is able to identify two such electric vehicles, one lacking battery power and the other having excessive battery power, and determine a suitable meeting location where they can exchange battery power. Thereby, it is an advantage that the electric vehicle that lacks battery power can have its battery recharged also when no charging station or other electricity source is available.

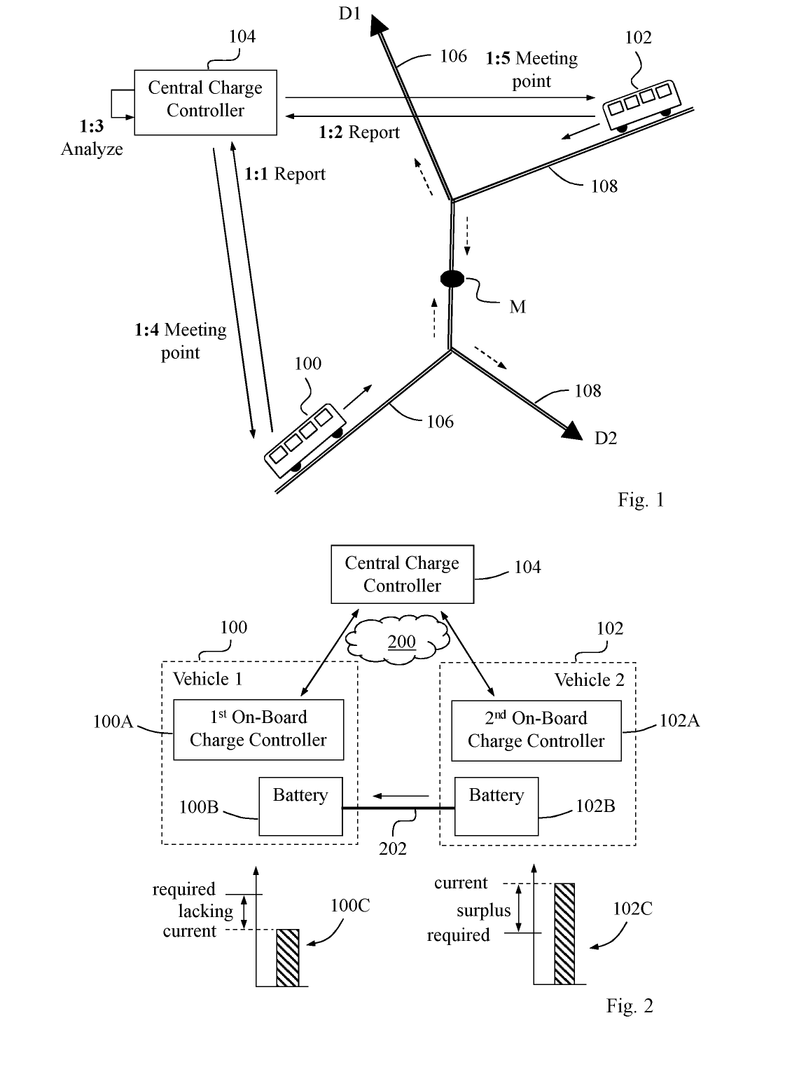

FIG. 1 is a scenario illustrating how this may be carried out by transferring battery power between a first electric vehicle 100 and a second electric vehicle 102. It should be noted that throughout this description, including basically all the following examples, the terminology of “first” and “second” is used interchangeably such that the procedures and features described herein are equally valid if these terms are switched.

The transfer of battery power is enabled by a central charge controller 104 which receives reports regularly sent from the vehicles and indicating their current battery charge level and intended route to a destination. In this figure, the destination of vehicle 100 is denoted D1 and the destination of vehicle 102 is denoted D2. Further, vehicle 100 travels on an intended route 106 towards D1 while vehicle 102 travels on another intended route 108 towards D2, as schematically indicated by dashed arrows. Either destination D1, D2 may be a final destination where the respective vehicle will finish its journey, or it may be a targeted charging station where the respective vehicle can recharge its battery in a conventional manner. A procedure for handling transfer of battery power between the first and second electric vehicles 100, 102 will now be described with further reference to FIG. 2 which illustrates the actual power transfer in more detail.

The procedure described herein is handled by a controlling function in each vehicle 100, 102 which in the following description will be referred to as an “on-board charge controller”, denoted 100A and 102A in FIG. 2. Each on-board charge controller may be implemented by a processor with software and suitable communication circuits for wireless communication with the central charge controller 104, to be described later below. Hence, the central charge controller 104 cooperates with the respective on-board charge controllers to achieve the functionality and features described herein. FIG. 2 further illustrates that each on-board charge controller 100A, 100B and the central charge controller 104 may communicate with each other over a cellular network 200 or over some dedicated radio link, depending on implementation. The solution is generally not limited to any particular technique for the communication.

In FIG. 1, action 1:1 and action 1:2 illustrate that the first and second vehicles 100, 102, respectively, send their reports to the central charge controller 104, e.g. on a more or less regular basis. Each report comprises at least an intended route to a destination and an indication of a current charge level in their respective batteries 100B and 102B. The central charge controller 104 may receive such reports with current charge level and intended route from any number of electric vehicles, although only two vehicles are discussed in the examples of this description for simplicity. For example, there may be a substantially larger number of electric vehicles, such as a fleet or the like with, say, 10-100 vehicles or more, that are “subscribers” to a service for exchange of battery power in the manner described herein. Further, all or some of the subscribers may belong to a taxi company or other enterprise with transport vehicles, and they may also include a mix of different vehicle categories, e.g. taxis, buses, lorries, private cars, etc., and the solution is not limited in this respect.

In this example, it may be assumed that one of the vehicles, say the first electric vehicle 100, has not enough battery power to propel, or drive, the first vehicle all the way to its destination D1, and this vehicle 100 thus needs to have its battery 100B recharged in order to reach the destination D1. It may be further assumed that the second electric vehicle 102 has more battery power than it needs to propel, or drive, the second vehicle to its destination D2. This vehicle 102 has thus surplus battery power that could be transferred from the second vehicle's battery 102B to the first vehicle's battery 100B if their reported intended routes at least partly coincide, more or less, and have some location or area in common that is suitable for the transfer of battery power.

Having received the reports in actions 1:1 and 1:2, the central charge controller 104 analyzes the reports, as indicated by a next action 1:3, and finds out that the first electric vehicle 100 needs additional battery power to reach D1, and that surplus battery power can be discharged from the second electric vehicle 102 which can still reach D2 by means of its remaining battery power. As said, each report indicates at least a current battery charge level and an intended route to a destination, and from this information the central charge controller 104 is further able to calculate how much battery power is required to reach the respective destination, and to determine whether the current battery charge level is sufficient to provide the required battery power or not.

For example, the report from vehicle 100 may further indicate an amount of lacking battery power that needs to be charged to its battery for reaching destination D1. Further, the report from vehicle 102 may indicate an amount of surplus battery power that can be discharged to its battery without the risk of not reaching destination D2. Alternatively, the central charge controller 104 may itself calculate the respective lacking and surplus battery powers from the respective reported current battery charge levels and intended routes.

The reports of actions 1:1 and 1:2 may further comprise one or more of a current position, current battery consumption rate and current speed of the respective vehicles, which information may be used to determine the lacking and surplus battery powers with better accuracy, since these factors more or less influence how much battery power will be consumed by each respective vehicle to reach its respective destination. Alternatively, an expected battery consumption rate and expected speed of the respective vehicles may be estimated from information about each vehicle's earlier “behavior”, or rather the driver's behavior, which information may have been recorded previously and stored in a database or the like. Such a database may be maintained in a cloud-like environment or in a dedicated data storage. The vehicles' current position may also be available from a separate information source apart from the reports, such as a GPS-based positioning service or the like. Another option is to obtain the expected battery consumption rate from a description of the vehicle model which may specify battery consumption characteristics, e.g. from a manufacturer of the vehicle. Such information may thus be used as well as a basis for determining any lacking or surplus battery power.

In action 1:3, the central charge controller 104 further compares the intended routes and determines whether the vehicles 100, 102 are able to meet at some location that can be reached from both routes 106, 108 and where they can transfer battery power between their batteries. FIG. 1 illustrates that the intended routes 106 and 108 coincide along a certain stretch common to both routes 106, 108, and the central charge controller 104 determines a proposed location, referred to as meeting point “M”, where the first and second electric vehicles 100, 102 can meet and exchange battery power. The meeting location M is thus determined based on the received first and second reports.

In action 1:4 and action 1:5, the central charge controller 104 sends the proposed location M to the first and second electric vehicles 100, 102, respectively, thereby enabling them to exchange battery power at the proposed location M. In practice, the proposed location M may be presented to the respective driver in a suitable manner so that they can drive their vehicles to the meeting location M and arrange for the power transfer. This solution is also applicable to driver-less vehicles where basically all operations described herein may be wholly automated.

A left-side diagram in FIG. 2 illustrates that, according to the report of action 1:1, the battery 100B in the first vehicle 100 has a current battery charge level 100C which is below a battery charge level required for propelling the first electric vehicle 100 to the destination D1. An amount of lacking battery power in vehicle 100 is also indicated by a two-way arrow in the left-side diagram. Further, a right-side diagram in FIG. 2 illustrates that, according to the report of action 1:2, the battery 102B in the second vehicle 102 has a current battery charge level 102C which is above a battery charge level required for propelling the second electric vehicle 102 to the destination D2. An amount of surplus battery power in vehicle 102 is indicated by another two-way arrow in the right-side diagram.

In this example, the amount of surplus battery power in vehicle 102 is larger than the amount of lacking battery power in vehicle 100. Thereby, the amount of battery power that needs to be transferred from vehicle 102 to vehicle 100 will not exceed the amount of surplus battery power in vehicle 102. The level of required battery power may be explicitly specified in the reports, or it may be calculated by the central charge controller 104 by estimating how much battery power will be consumed to reach the respective destination.

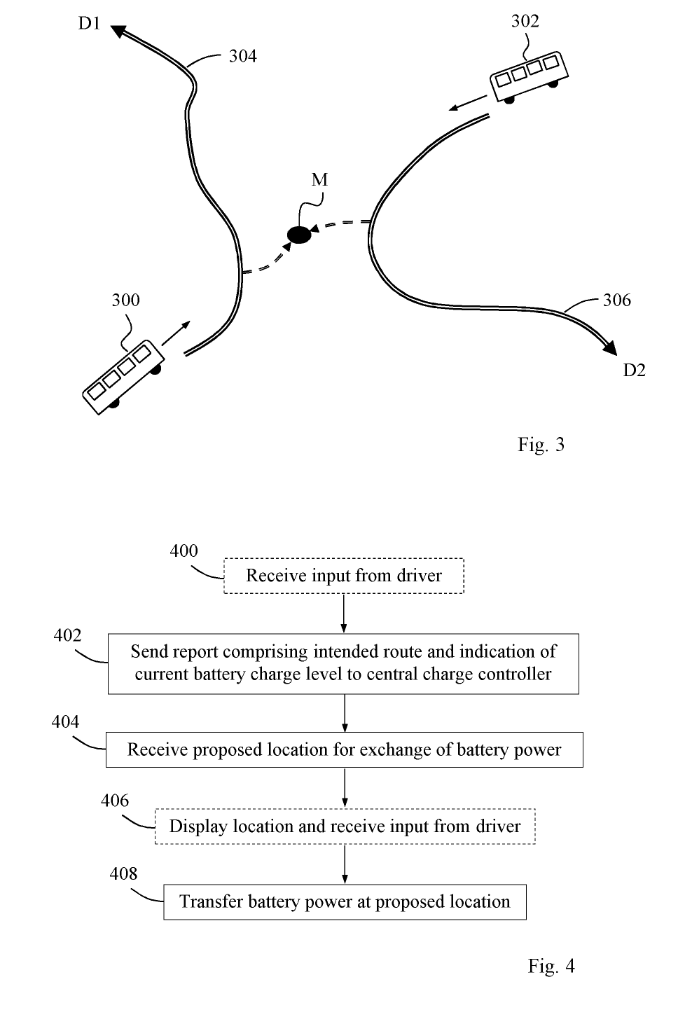

FIG. 3 illustrates another example of using the above-described procedure where a first electric vehicle 300 travels on an intended route 304 towards a destination D1 and a second electric vehicle 303 travels on an intended route 306 towards another destination D2, where the routes 304 and 306 never exactly coincide but are reasonably close to one another at some stretch. In this case, a proposed meeting location M is determined by the central charge controller, not shown, to be at a suitable spot somewhere between the routes 304 and 306 where they are sufficiently close to one another for the vehicles to meet. In this case, the vehicles will need to take a small detour from their routes to reach the location M, as indicated by dashed arrows. In general, the central charge controller may preferably try to find a proposed meeting location M that is located at some facility where the drivers can rest and/or get something to eat.

An example of how the solution may be employed in terms of actions performed by an on-board charge controller, will now be described with reference to the flow chart in FIG. 4 which illustrates how the on-board charge controller, such as either of the on-board charge controllers 100A and 102A in FIG. 2, may operate to accomplish the functionality described above.

The on-board charge controller is arranged to be used in a first electric vehicle powered by a rechargeable battery, for handling battery charge. The first electric vehicle in this procedure may be any of the above-described vehicles 100, 102, 300 and 302. A first optional action 400 illustrates that the on-board charge controller may receive input from the vehicle's driver such as a destination and/or intended route, which may be entered by the driver on a navigator screen or other input means. In a next action 402, the on-board charge controller sends a report to a central charge controller, corresponding to the node 104 described above, the report comprising an intended route to a destination, e.g. D1 above, to be travelled by the first electric vehicle, and an indication of a current battery charge level.

In a further action 404, the on-board charge controller receives, from the central charge controller, a proposed location where a second electric vehicle, e.g. the above-described vehicle 102, can exchange battery power with the first electric vehicle. The central charge controller has thus analyzed the report sent from the first vehicle in action 402 and also a similar report that the second vehicle has sent to the central charge controller, and has concluded that one of the first and second vehicles is able to provide some battery power to the other vehicle, and that the vehicles are able to meet at the proposed location for transferring power between their batteries. In this action, the on-board charge controller may also receive an instruction from the central charge controller specifying the direction of power transfer and also the amount of battery power to be transferred.

In another optional action 406, the on-board charge controller may inform the driver by displaying the proposed location for battery transfer, and an acknowledgement or similar may also be received as input from the driver, e.g. confirming that the first vehicle has reached the proposed location and that the battery power transfer can begin. As in action 400 above, this interaction with the driver may be performed over a suitable screen such as a navigator screen.

A final action 408 illustrates that the on-board charge controller transfers battery power between a rechargeable battery of the second electric vehicle and the battery of the first electric vehicle at the proposed location. In this action, the battery power may be transferred in either direction, i.e. either from the first vehicle to the second vehicle or from the second vehicle to the first vehicle, depending on the report sent in action 402. Various optional embodiments are possible to employ in the above procedure as follows.

In one possible embodiment, battery power may be received from the battery of the second electric vehicle if the current battery charge level in the first vehicle is below a battery charge level required for propelling the first electric vehicle to the destination. In another possible embodiment, the indication in the report of action 402 may indicate an amount of lacking battery power that needs to be charged to the battery of the first electric vehicle, such that at least said amount of lacking battery power is transferred from the battery of the second electric vehicle to the battery of the first electric vehicle. In another possible embodiment, the on-board charge controller may send a request for extra battery power to the central charge controller when detecting that the current battery charge level is insufficient for propelling the first electric vehicle to the destination. This request may be sent together with the report of action 402 or separately once the lack of battery power is recognized in the first vehicle.

Further optional embodiments are possible to employ in the above procedure as follows. In one possible embodiment, battery power may be supplied to the battery of the second electric vehicle if the current battery charge level is above a battery charge level required for propelling the first electric vehicle to the destination. That is, the first vehicle has surplus, or excessive, battery power, at least for the present journey to said destination. In another possible embodiment, the indication in the report of action 402 may indicate an amount of surplus battery power that can be discharged from the battery of the first electric vehicle. In this case, the amount of transferred battery power should not exceed the amount of surplus battery power in the first vehicle, thus to ensure that the first vehicle will have enough battery power left after the transfer to reach its destination.

In another possible embodiment, the report sent in action 402 may further comprise at least one of a current position, a current battery consumption rate and a current speed of the first electric vehicle. As mentioned above, this type of information may be used by the central charge controller to determine any lacking or surplus battery power and/or meeting location with better accuracy, since these factors more or less influence how much battery power will be consumed by the first vehicle to reach its destination, as well as the timing of the vehicle's journey which is useful for arranging a suitable meeting with the second vehicle. In yet another possible embodiment, the on-board charge controller may receive at least one of an identification of the second electric vehicle and a proposed meeting time from the central charge controller. This information may likewise be presented to the driver in a suitable manner.

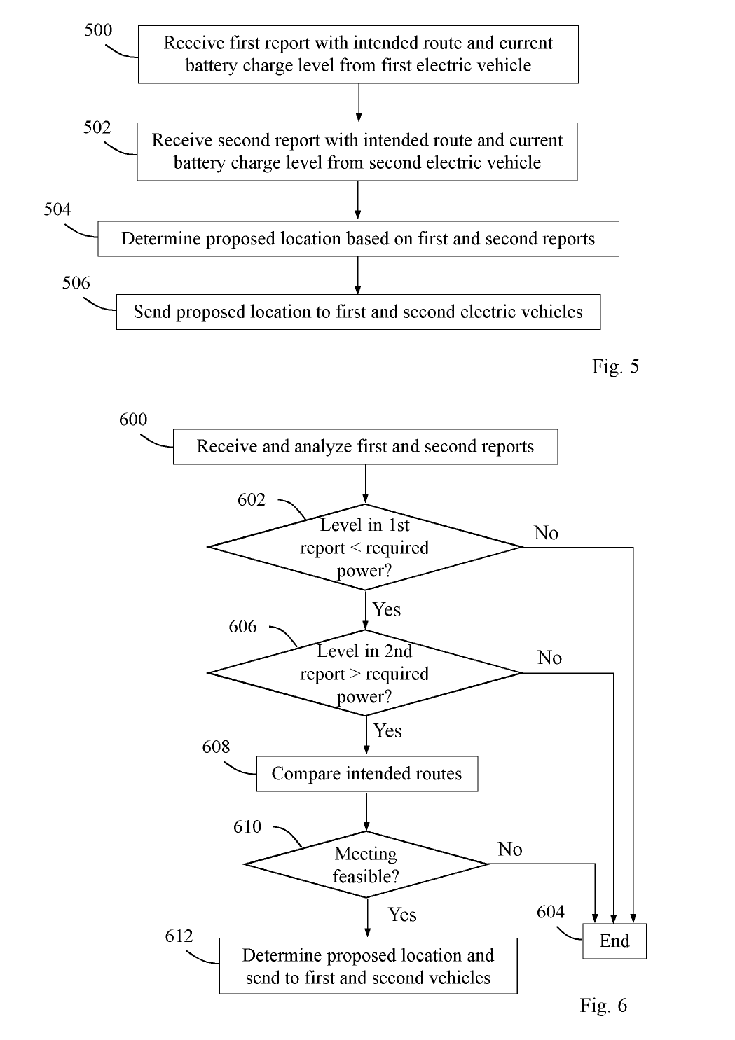

An example of how the solution may be employed in terms of actions performed by a central charge controller, will now be described with reference to the flow chart in FIG. 5 which illustrates how the central charge controller, such as the above central charge controller 104, may operate to accomplish the functionality described above.

The central charge controller is arranged for handling battery charge in a rechargeable battery of a first electric vehicle, e.g. the above vehicle 100, and in a rechargeable battery of a second electric vehicle, e.g. the above vehicle 102. The procedure illustrated in FIG. 5 may be performed in interaction with at least two on-board charge controllers operating in electric vehicles according to the above-described procedure illustrated in FIG. 4.

In a first action 500, the central charge controller receives a first report from the first electric vehicle, e.g. as described for action 1:1 above. The first report comprises an intended route to a first destination to be travelled by the first electric vehicle and an indication of a current battery charge level in the first electric vehicle. Another action 502 illustrates that the central charge controller also receives a second report from the second electric vehicle, e.g. as described for action 1:2 above. The second report similarly comprises an intended route to a second destination to be travelled by the second electric vehicle and an indication of a current battery charge level in the second electric vehicle.

In a further action 504, the central charge controller determines a proposed location where the first and second electric vehicles can exchange battery power, based on the received first and second reports. Some examples of how this action may be performed will be described later below. The central charge controller finally sends the proposed location to the first and second electric vehicles, in an action 506, thereby enabling the first and second electric vehicles to exchange battery power at the proposed location.

Some optional embodiments are possible to employ in the above procedure as well. As indicated in the preceding examples, the central charge controller analyzes the reports received from the first and second vehicles and recognizes that one of them needs to add more battery power to reach its destination, and that the other vehicle is able to discharge some surplus battery power. This analysis also reveals that the vehicles are able to meet at the proposed location for transferring power between their batteries. A more detailed example of how the central charge controller may execute this analysis will be described later below with reference to the flow chart in FIG. 6.

Depending on the outcome of the analysis, the central charge controller may, in one possible embodiment, send an instruction to the first and second vehicles to transfer battery power from the battery of the second electric vehicle to the battery of the first electric vehicle, if the current battery charge level in the first report is below a battery charge level required for propelling the first electric vehicle along its intended route and the current battery charge level in the second report is above a battery charge level required for propelling the second electric vehicle along its intended route.

In another possible embodiment, if the first report indicates an amount of lacking battery power that needs to be charged to the battery in the first electric vehicle, the central charge controller may send an instruction to the first and second vehicles to transfer at least said amount of lacking battery power from the battery of the second electric vehicle to the battery of the first electric vehicle. Alternatively, the amount of battery power to transfer may be controlled by the first vehicle, that is by the on-board charge controller therein.

In further possible embodiments, the central charge controller may use at least one of a current position, a current battery consumption rate and a current speed of the first and second electric vehicles comprised in the received first and second reports, respectively, for determining said proposed location. It was mentioned above that these factors may be used to increase the accuracy of the above analysis.

An illustrative but non-limiting example of how the central charge controller may operate to basically accomplish the above action 504, will now be described referring to FIG. 6. A first action 600 indicates that the central charge controller receives and analyzes the aforementioned first and second reports coming from the first and second electric vehicles, respectively. As described above, each report comprises at least an intended route to a destination and an indication of a current battery charge level in the respective vehicles. It should be noted that the procedure in FIG. 6 evaluates only two vehicles at a time and that it may be repeated for different pairs of vehicles before finding two vehicles suitable for transfer of battery power.

In a next action 602, the central charge controller checks if the current battery charge level in the first report is below a battery charge level required for propelling the first electric vehicle to its destination. If not, the first vehicle is apparently able to reach its destination without having to add any extra battery power, and the process may in that case end in an action 604.

On the other hand, if the current battery charge level in the first report is below the required battery charge level, the first vehicle must apparently add extra battery power in order to reach its destination. In that case the central charge controller proceeds to check, in another action 606, if the current battery charge level in the second report is above a battery charge level required for propelling the second electric vehicle to its destination. If not, the second vehicle is apparently not able to supply any battery power without running out of battery power before reaching its own destination, and the process may in that case too end in action 604.

On the other hand, if the current battery charge level in the second report is above the required battery charge level, the second vehicle apparently has surplus battery power to share with the first vehicle. In that case the central charge controller proceeds to compare the vehicles' intended routes in another action 608, to see if a meeting is feasible which is checked in action 610. If the routes are too far away from one another, or if no time for the meeting can be found that is reasonable for both vehicles, the process may end as of action 604. If a meeting is feasible, a final action 612 illustrates schematically that the central charge controller determines a proposed meeting location and sends it to the first and second vehicles, thus corresponding to actions 504 and 506.

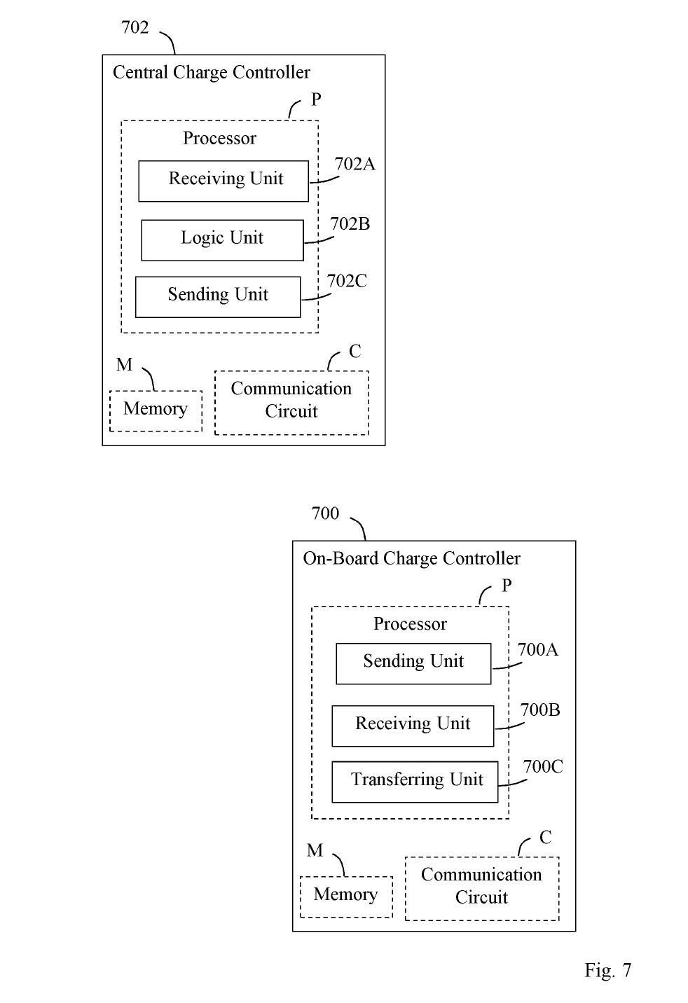

The block diagram in FIG. 7 illustrates a detailed but non-limiting example of how an on-board charge controller 700 and a central charge controller 702, respectively, may be structured to bring about the above-described solution and embodiments thereof. In this figure, the on-board charge controller 700 and the central charge controller 702 may be configured to operate according to any of the examples and embodiments of employing the solution as described above, where appropriate, and as follows. Each of the on-board charge controller 700 and the central charge controller 702 is shown to comprise a processor “P”, a memory “M” and a communication circuit “C” with suitable equipment for transmitting and receiving information and messages in the manner described herein.

The communication circuit C in each of the on-board charge controller 700 and the central charge controller 702 thus comprises equipment configured for communication e.g. over a cellular network or other radio links using a suitable protocol for radio communication depending on the implementation. The solution is however not limited to any specific types of data or protocols.

The on-board charge controller 700 comprises means configured or arranged to perform at least some of the actions 400-408 of the flow chart in FIG. 4 in the manner described above. The central charge controller 702 comprises means configured or arranged to perform the actions 500-506 of the flow chart in FIG. 5 in the manner described above. The actions of FIGS. 4 and 5 may be performed by means of functional units in the respective processor P in the on-board charge controller 700 and the central charge controller 702.

The on-board charge controller 700 is arranged to handle battery charge at a first electric vehicle powered by a rechargeable battery. The on-board charge controller 700 thus comprises the processor P and the memory M, said memory comprising instructions executable by said processor, whereby the on-board charge controller 700 is operative as follows.

The on-board charge controller 700 is operative to send, to the central charge controller 702, a report comprising an intended route to a destination to be travelled by the first electric vehicle and an indication of a current battery charge level. This operation may be performed by a sending unit 700A in the on-board charge controller 700, e.g. in the manner described for action 402 above.

The on-board charge controller 700 is also operative to receive, from the central charge controller 702, a proposed location where a second electric vehicle can exchange battery power with the first electric vehicle. This operation may be performed by a receiving unit 700B, e.g. in the manner described for action 404 above. The on-board charge controller 700 is also operative to transfer battery power between a rechargeable battery of the second electric vehicle and the battery of the first electric vehicle at the proposed location. This operation may be performed by a transferring unit 700C, e.g. in the manner described for action 408 above.

The central charge controller 702 is arranged to handle battery charge in a rechargeable battery of a first electric vehicle and in a rechargeable battery of a second electric vehicle. The central charge controller 702 thus comprises the processor P and the memory M, said memory comprising instructions executable by said processor, whereby the central charge controller 702 is operative as follows.

The central charge controller 702 is operative to receive a first report from the first electric vehicle, the first report comprising an intended route to a first destination to be travelled by the first electric vehicle and an indication of a current battery charge level in the first electric vehicle. This operation may be performed by a receiving unit 702A in the central charge controller 702, e.g. in the manner described for action 500 above. The central charge controller 702 is also operative to receive a second report from the second electric vehicle, the second report comprising an intended route to a second destination to be travelled by the second electric vehicle and an indication of a current battery charge level in the second electric vehicle. This operation may be performed by the receiving unit 702A in the central charge controller 702, e.g. in the manner described for action 502 above.

The central charge controller 702 is also operative to determine a proposed location where the first and second electric vehicles can exchange battery power, based on the received first and second reports. This operation may be performed by a logic unit 702B in the central charge controller 702, e.g. in the manner described for action 504 above. The central charge controller 702 is also operative to send the proposed location to the first and second electric vehicles, thereby enabling the first and second electric vehicles to exchange battery power at the proposed location. This operation may be performed by a sending unit 702C in the central charge controller 702, e.g. in the manner described for action 506 above.

It should be noted that FIG. 7 illustrates various functional modules in the on-board charge controller 700 and the central charge controller 702, respectively, and the skilled person is able to implement these functional modules in practice using suitable software and hardware. Thus, the solution is generally not limited to the shown structures of the on-board charge controller 700 and the central charge controller 702, and the functional modules 700a-c and 702a-c therein may be configured to operate according to any of the features and embodiments described in this disclosure, where appropriate.

The functional modules 700a-c and 702a-c described above can be implemented in the on-board charge controller 700 and the central charge controller 702, respectively, by means of program modules of a respective computer program comprising code means which, when run by the processor P causes the on-board charge controller 700 and the central charge controller 702 to perform the above-described actions and procedures. Each processor P may comprise a single Central Processing Unit (CPU), or could comprise two or more processing units. For example, each processor P may include a general purpose microprocessor, an instruction set processor and/or related chips sets and/or a special purpose microprocessor such as an Application Specific Integrated Circuit (ASIC). Each processor P may also comprise a storage for caching purposes.

Each computer program may be carried by a computer program product in each of the on-board charge controller 700 and the central charge controller 702 in the form of a memory having a computer readable medium and being connected to the processor P. The computer program product or memory M in each of the on-board charge controller 700 and the central charge controller 702 thus comprises a computer readable medium on which the computer program is stored e.g. in the form of computer program modules or the like. For example, the memory M in each node may be a flash memory, a Random-Access Memory (RAM), a Read-Only Memory (ROM) or an Electrically Erasable Programmable ROM (EEPROM), and the program modules could in alternative embodiments be distributed on different computer program products in the form of memories within the respective on-board charge controller 700 and central charge controller 702.

The solution described herein may be implemented in each of the on-board charge controller 700 and the central charge controller 702 by a computer program comprising instructions which, when executed on at least one processor, cause the at least one processor to carry out the actions according to any of the above embodiments, where appropriate. The solution may also be implemented at each of the on-board charge controller 700 and the central charge controller 702 in a carrier containing the above computer program, wherein the carrier is one of an electronic signal, optical signal, radio signal, or computer readable storage medium.

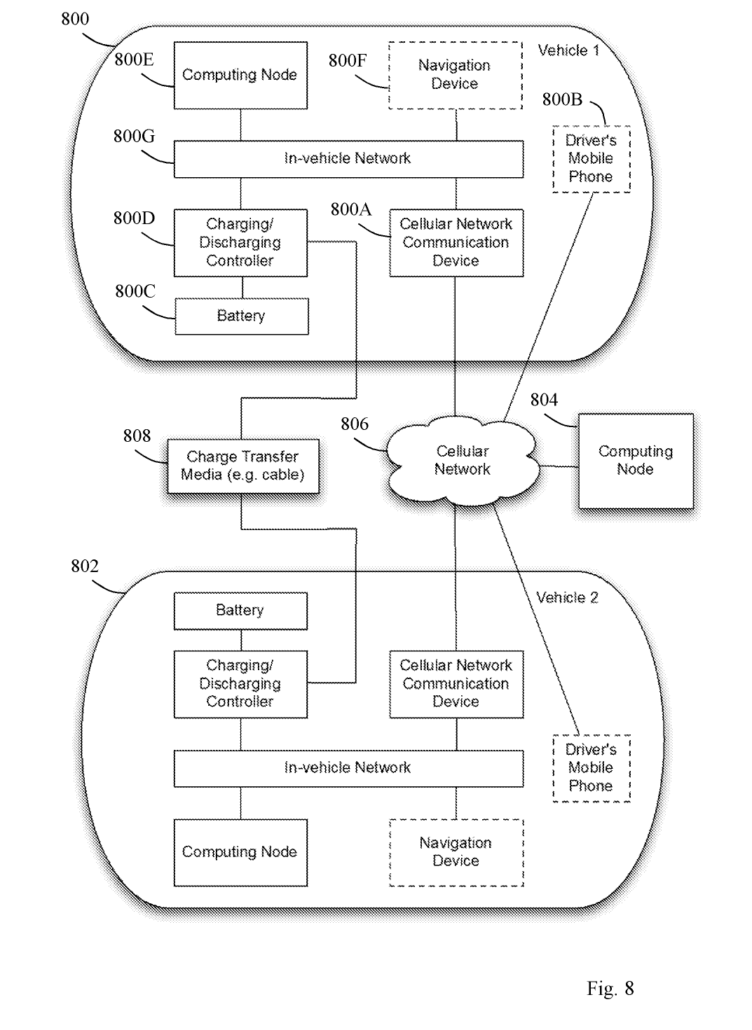

An illustrative but non-limiting example of how the above-described on-board charge controller may be employed in two electric vehicles 800 and 802 is illustrated by the block diagram in FIG. 8. This arrangement in the vehicles will be briefly described for one vehicle 800 only for simplicity, although it is also valid and useful in the other vehicle 802. The first and second vehicles 800, 802 are operable to communicate in the manner described above with a central charge controller 804, here denoted “computing node”, over a cellular network 806. For this communication, a cellular network communication device 800A that is installed in the vehicle or a loose mobile phone 800B may be used.

Each vehicle has a rechargeable battery 800C and a charging/discharging controller 800D comprising suitable logic for controlling the amount of battery power that is transferred from one battery to the other. A cable or other charge transfer media 808 is used to physically connect the batteries via the charging/discharging controllers for the power transfer. For example, such a cable or the like may be available at the chosen meeting point.

A computing node 800E is also used in the vehicles for preparing reports to be sent to the central charge controller 804, and for processing instructions and proposed meeting locations when received from the central charge controller 804. A navigation device 800F may further be used in the vehicle to guide the driver and to provide the intended route based on a destination that is entered by the driver in the navigation device 800F. Each vehicle may also have a local network 800G that connects the above components as shown for internal communication. The on-board charge controller as described herein would in the example of FIG. 8 include at least the charging/discharging controller 800D, the computing node 800E and the cellular network communication device 800A.

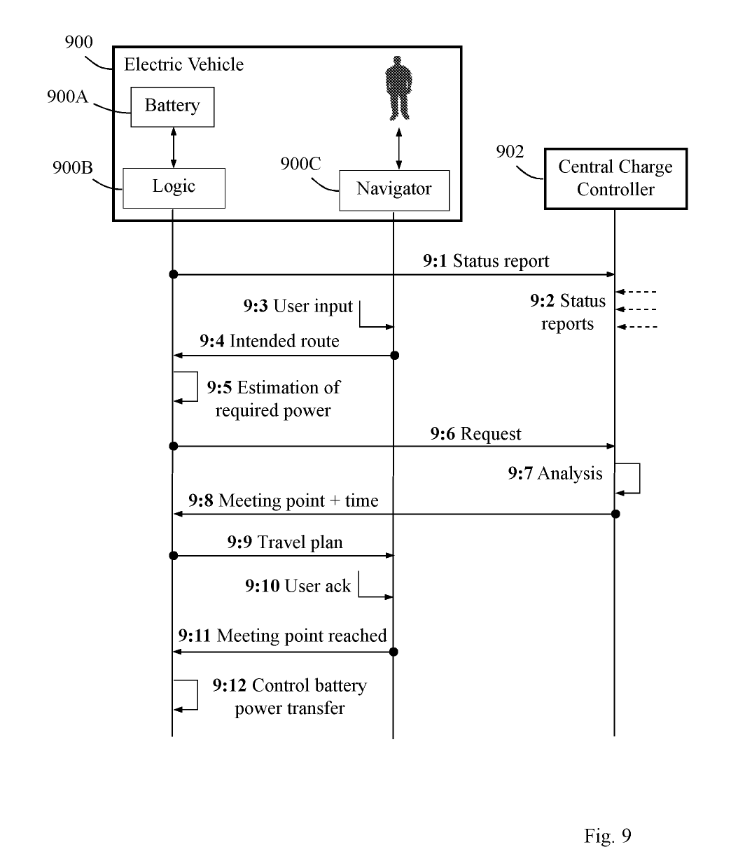

A more detailed example of how the solution may be employed will now be described with reference to the signaling diagram in FIG. 9 which illustrates the communication between an electrical vehicle 900 and a central charge controller 902 for transfer of battery power to or from a rechargeable battery 900A in the vehicle 900. A logic function 900B and a navigator function 900C basically add up to provide the above-described on-board charge controller in the vehicle 900 as follows.

A first action 9:1 illustrates that the logic function 900B sends a status report with a current battery charge level to the central charge controller 902, e.g. basically in the manner described for action 402 above. Another action 9:2 indicates schematically that that the central charge controller 902 receives such status reports with intended routes and current battery charge levels from other electric vehicles as well, e.g. basically in the manner described for actions 500 and 502 above. The navigator 900C receives input from a driver of the vehicle 900 or from another person, in an action 9:3, e.g. when a destination is entered by the driver or other person. The navigator 900C then determines a suitable intended route that can be travelled by the vehicle 900 to reach the destination, and sends the intended route to the logic 900B, in an action 9:4.

Next, the logic 900B estimates how much battery power is required to propel the vehicle 900 along the intended route to reach the destination, in an action 9:5. In this example, the logic 900B arrives at the conclusion that the current battery charge level is not sufficient to propel the vehicle all the way to the destination, and sends a request for more battery power to the central charge controller 902 in an action 9:6. Having received status reports and the request from the vehicle 900, the central charge controller 902 analyzes the received information in another action 9:7, in order to find another vehicle with surplus battery power and to find a feasible meeting location and time for transfer of battery power from the other vehicle, not shown, e.g. basically in the manner described for action 504 above.

The central charge controller 902 accordingly sends the meeting location and a proposed meeting time to the logic 900B, in a following action 9:8, which corresponds to actions 404 and 506 above. The central charge controller 902 may also provide instructions to vehicle 900 such as the amount of battery power to transfer and a registration number of the other vehicle to help the driver of vehicle 900 to find the other vehicle. The logic 900B then determines a travel plan for getting to the proposed meeting location at the proposed time and conveys it to the navigator 900C in a further action 9:9. The navigator 900C displays the travel plan to the driver who acknowledges the plan in another action 9:10. An acknowledgement may also be sent to the central charge controller 902 which in turn may notify the other vehicle that the driver of vehicle 900 has agreed to transfer battery power at the meeting point. Later, the navigator confirms to the logic 900B that the meeting location has been reached, in an action 9:11. A final action 9:12 illustrates that the logic 900B controls the actual transfer of battery power from the other vehicle to the vehicle 900, e.g. basically in the manner described for action 408 above.

While the solution has been described with reference to specific exemplifying embodiments, the description is generally only intended to illustrate the inventive concept and should not be taken as limiting the scope of the solution. For example, the terms “on-board charge controller”, “central charge controller” and “electric vehicle” have been used throughout this disclosure, although any other corresponding entities, functions, and/or parameters could also be used having the features and characteristics described here. The solution is defined by the appended claims.

1-25. (canceled)

26. A method, performed by an on-board charge controller of a first electric vehicle powered by a rechargeable battery, for handling battery charge, the method comprising:
sending, to a central charge controller, a report comprising an intended route to a destination to be travelled by the first electric vehicle and an indication of a current battery charge level;
receiving, from the central charge controller, a proposed location where a second electric vehicle can exchange battery power with the first electric vehicle; and
transferring battery power between a rechargeable battery of the second electric vehicle and the battery of the first electric vehicle at the proposed location.

27. The method of claim 26, wherein battery power is received from the battery of the second electric vehicle if the current battery charge level is below a battery charge level required for propelling the first electric vehicle to the destination.

28. The method of claim 27, wherein
the indication indicates an amount of lacking battery power that needs to be charged to the battery of the first electric vehicle; and
at least the amount of lacking battery power is transferred from the battery of the second electric vehicle to the battery of the first electric vehicle.

29. The method of claim 27, further comprising sending a request for extra battery power to the central charge controller when detecting that the current battery charge level is insufficient for propelling the first electric vehicle to the destination.

30. The method of claim 26, wherein battery power is supplied to the battery of the second electric vehicle if the current battery charge level is above a battery charge level required for propelling the first electric vehicle to the destination.

31. The method of claim 30, wherein:
the indication indicates an amount of surplus battery power that can be discharged from the battery of the first electric vehicle; and
the amount of transferred battery power does not exceed the amount of surplus battery power.

32. The method of claim 26, wherein at least one of an identification of the second electric vehicle and a proposed meeting time is received from the central charge controller.

33. An on-board charge controller adapted to operate in a first electric vehicle powered by a rechargeable battery, the on-board charge controller being arranged to handle battery charge, the on-board charge controller comprising:
processing circuitry;
memory containing instructions executable by the processing circuitry whereby the on-board charge controller is operative to:
send, to a central charge controller, a report comprising an intended route to a destination to be travelled by the first electric vehicle and an indication of a current battery charge level;
receive, from the central charge controller, a proposed location where a second electric vehicle can exchange battery power with the first electric vehicle; and
transfer battery power between a rechargeable battery of the second electric vehicle and the battery of the first electric vehicle at the proposed location.

34. The on-board charge controller of claim 33, wherein the on-board charge controller is configured to transfer battery power from the battery of the second electric vehicle if the current battery charge level is below a battery charge level required for propelling the first electric vehicle to the destination.

35. The on-board charge controller of claim 34, wherein when the indication indicates an amount of lacking battery power that needs to be charged to the battery of the first electric vehicle, the on-board charge controller is configured to transfer at least the amount of lacking battery power from the battery of the second electric vehicle to the battery of the first electric vehicle.

36. The on-board charge controller of claim 34, wherein the on-board charge controller is configured to send a request for extra battery power to the central charge controller when detecting that the current battery charge level is insufficient for propelling the first electric vehicle to the destination.

37. The on-board charge controller of claim 33, wherein the on-board charge controller is configured to supply battery power to the battery of the second electric vehicle if the current battery charge level is above a battery charge level required for propelling the first electric vehicle to the destination.

38. The on-board charge controller of claim 37, wherein:
the indication indicates an amount of surplus battery power that can be discharged from the battery of the first electric vehicle; and
the amount of transferred battery power does not exceed the amount of surplus battery power.

39. The on-board charge controller of claim 33, wherein the on-board charge controller is configured to receive at least one of an identification of the second electric vehicle and a proposed meeting time from the central charge controller.

40. A method, performed by a central charge controller, for handling battery charge in a rechargeable battery of a first electric vehicle and in a rechargeable battery of a second electric vehicle, the method comprising:
receiving a first report from the first electric vehicle, the first report comprising an intended route to a first destination to be travelled by the first electric vehicle and an indication of a current battery charge level in the first electric vehicle;
receiving a second report from the second electric vehicle, the second report comprising an intended route to a second destination to be travelled by the second electric vehicle and an indication of a current battery charge level in the second electric vehicle;
determining, based on the received first and second reports, a proposed location where the first and second electric vehicles can exchange battery power; and
sending the proposed location to the first and second electric vehicles, thereby enabling the first and second electric vehicles to exchange battery power at the proposed location.

41. The method of claim 40, wherein the central charge controller sends an instruction to the first and second vehicles to transfer battery power from the battery of the second electric vehicle to the battery of the first electric vehicle if the current battery charge level in the first report is below a battery charge level required for propelling the first electric vehicle along its intended route and the current battery charge level in the second report is above a battery charge level required for propelling the second electric vehicle along its intended route.

42. The method of claim 41, wherein:
the first report indicates an amount of lacking battery power that needs to be charged to the battery in the first electric vehicle; and
the central charge controller sends an instruction to the first and second vehicles to transfer at least the amount of lacking battery power from the battery of the second electric vehicle to the battery of the first electric vehicle.

43. A central charge controller arranged to handle battery charge in a rechargeable battery of a first electric vehicle and in a rechargeable battery of a second electric vehicle, the central charge controller comprising:
processing circuitry;
memory containing instructions executable by the processing circuitry whereby the central charge controller is operative to:
receive a first report from the first electric vehicle, the first report comprising an intended route to a first destination to be travelled by the first electric vehicle and an indication of a current battery charge level in the first electric vehicle;
receive a second report from the second electric vehicle, the second report comprising an intended route to a second destination to be travelled by the second electric vehicle and an indication of a current battery charge level in the second electric vehicle;
determine, based on the received first and second reports, a proposed location where the first and second electric vehicles can exchange battery power; and
send the proposed location to the first and second electric vehicles, thereby enabling the first and second electric vehicles to exchange battery power at the proposed location.

44. The central charge controller of claim 43, wherein the central charge controller is configured to send an instruction to the first and second vehicles to transfer battery power from the battery of the second electric vehicle to the battery of the first electric vehicle if the current battery charge level in the first report is below a battery charge level required for propelling the first electric vehicle along its intended route and the current battery charge level in the second report is above a battery charge level required for propelling the second electric vehicle along its intended route.

45. The central charge controller of claim 44, wherein:
the first report indicates an amount of lacking battery power that needs to be charged to the battery in the first electric vehicle; and
the central charge controller is configured to send an instruction to the first and second vehicles to transfer at least the amount of lacking battery power from the battery of the second electric vehicle to the battery of the first electric vehicle.
